(19) United States
(12) Patent Application Publication
(10) Pub. No.: US 2015/0168752 A1
(43) Pub. Date: Jun. 18, 2015

(54) LIQUID CRYSTAL PANEL AND MANUFACTURING METHOD THEREOF

(71) Applicant: Shenzhen China Star Optoelectronics Technology Co. Ltd., Shenzhen (CN)

(72) Inventors: Minghung Shih, Shenzhen (CN); Zuomin Liao, Shenzhen (CN)

(21) Appl. No.: 13/703,360

(22) PCT Filed: Aug. 28, 2012
(86) PCT No.: PCT/CN12/80647

§ 371 Date: Dec. 11, 2012

(30) Foreign Application Priority Data
Aug. 16, 2012 (CN) 201210292358.7

(51) Int. Cl. G02F 1/1337; G02F 1/1368; G02F 1/1339

(52) U.S. Cl. CPC G02F 1/1337; G02F 1/1339; G02F 1/1368; G02F 2001/133776

(57) ABSTRACT

A liquid crystal panel is provided herein and comprises a top substrate, a bottom substrate and at least one sealant. The bottom substrate comprises a display region, a non-display region, a first limiting component and a second limiting component. The non-display region is adjacent to the display region. The first limiting component is formed as a convex at an edge of the non-display region. The second limiting component is formed as a concave between the first limiting component and the non-display region. When an alignment film is coated on the bottom substrate, the alignment film will not be spread to the non-display region by a conjunction of the first limiting component and the second limiting component.

### FIELD OF THE INVENTION

The present invention relates to a field of liquid crystal panels, and more particularly to a liquid crystal panel and a manufacturing method thereof.

### BACKGROUND OF THE INVENTION

A liquid crystal (LC) panel is a significant component in the LC display. The LC panel includes an array substrate, a color film substrate and LCs, which are disposed between the array substrate and the color film substrate. The LCs are aligned by an alignment film coated on the array substrate and the color film substrate to control the arrangement of the LCs and provide a pre-tilt angle for the need of the LC display, so as to achieve the display result of the LC panel. The commonly used alignment film is made of polyimide (PI) material, and the PI material has properties such as high heat resistance, chemical solvents resistance, as well as good radiation and electricity insulativity, and so on.

However, considering the properties that the insulativity of the PI and the adhesive force of the sealant are inadequate, when the alignment liquid is coated to form the alignment layer, it is not easy to control the diffusion of the alignment film, leading to a disadvantages that the edge of the alignment film is uneven and the size thereof is not easy to control. When the alignment film is spread to the area of the sealant, the strength of the sealant will be decreased and the quality of the sealant is affected. On the other hand, the alignment film is dried from outside to inside during the drying process, so the thickness at the edge of the alignment film is higher than the thickness at the center thereof. In addition, because the thickness of the alignment film is uneven, the problem of the uneven alignment would occur to affect the display quality.

In order to solve the problems above, the conventional method is to provide a structure to avoid the alignment film overlapping the sealant. FIG. IA is a structure sectional view illustrating a conventional substrate. As shown in FIG. 1A, a groove 102A is formed at the edge of an array substrate 10A. The groove 102A can receive the spread alignment liquid 104A, so the alignment liquid 104A will not be spread over the groove 102A to sealant 106A. However, if excess alignment liquid 104A is spread, the alignment liquid 104A would be spread over the groove 102A to the sealant 106A. Another conventional solution is to form a bump at the edge of the an⁻ay substrate. FIG. 1B is a structure sectional view illustrating another conventional array substrate. As shown in FIG. 1B, the bump 102B in the array substrate 10B can prevent the alignment liquid 104B from being spread to the area of the sealant 106B. However, in the area of the alignment liquid 104B adjacent to the bump 102B, the alignment liquid 104B possibly flows to the area of the sealant 106B because the alignment liquid is excess and flows to the area of the sealant 106B. Moreover, because the step formed by the groove or the bump is too small, the alignment liquid is easy to be spread over the groove or the bump and the design of the groove or the bump is failed.

Therefore, a need is arisen to design a structure with larger step on the array substrate to prevent the alignment liquid from overflowing.

### SUMMARY OF THE INVENTION

An object of the present invention is to provide a structure to prevent an alignment liquid from being spread to the sealant so as to affect the adhesion of the sealant.

For achieving the above-mentioned technical solution, the present invention proposes a LC panel and the LC panel comprises a top substrate, a bottom substrate and at least one sealant. The bottom substrate comprises a display region, a non-display region, a first limiting component and a second limiting component. The non-display region is adjacent to the display region. The first limiting component is formed to be a convex at an edge of the non-display region. The second limiting component is formed to be a concave between the first limiting component and the non-display region. When an alignment film is coated on the bottom substrate, the alignment film will not be spread to the non-display region through assembling the first limiting component and the second limiting component.

Another object of the present invention is to provide a liquid crystal (LC) panel manufacturing method to produce a structure to prevent the diffusion of the alignment liquid and decrease the distance between the edge of the display region and the edge of the panel so as to achieve the design of an ultra-thin frame.

For achieving the above-mentioned technical solution, the present invention proposes an LC panel manufacturing method, wherein the manufacturing method comprises following steps: a step of respectively stacking a plurality of thin films on a top substrate and a bottom substrate; a step of retaining a portion of the thin films on a side of a sealant to form a first limiting component when forming a plurality of the thin films on the bottom substrate; a step of etching a plurality of the thin films on the bottom substrate to form a second limiting component; and a step of coating an alignment film on the bottom substrate to form an alignment layer. By a conjunction of the first limiting component and the second limiting component, during the process to coat the alignment film, the first limiting component and the second limiting component are utilized to prevent the alignment film from being spread to an area of the sealant so as to avoid the alignment film overlapping the sealant.

According to the description above, the advantages of the present invention is: by the structure of the first limiting component and the second limiting component, the first limiting component and the second limiting component are utilized to prevent the alignment film from being spread to the area of the sealant during the process for coating the alignment film. In other words, by the installation of the first limiting component and the second limiting component, the purpose of evenly coating the alignment film can be achieved and the distance between the edge of the display region and the edge of the panel can be decreased to easily accomplish the purpose of the ultra-thin frame.

The above-mentioned description of the present invention can be best understood by referring to the following detailed description of the preferred embodiments and the accompanying drawings.

### DESCRIPTION OF THE DRAWINGS

FIG. 1A is a structure sectional view illustrating a conventional array substrate;

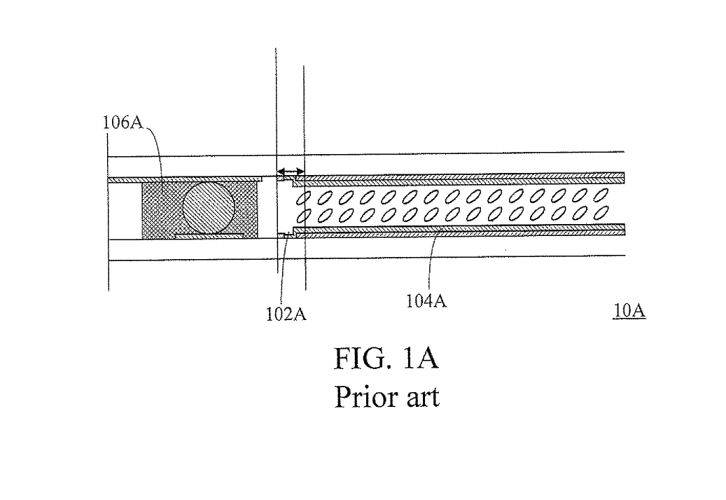

FIG. 1B is a structure sectional view illustrating another conventional array substrate;

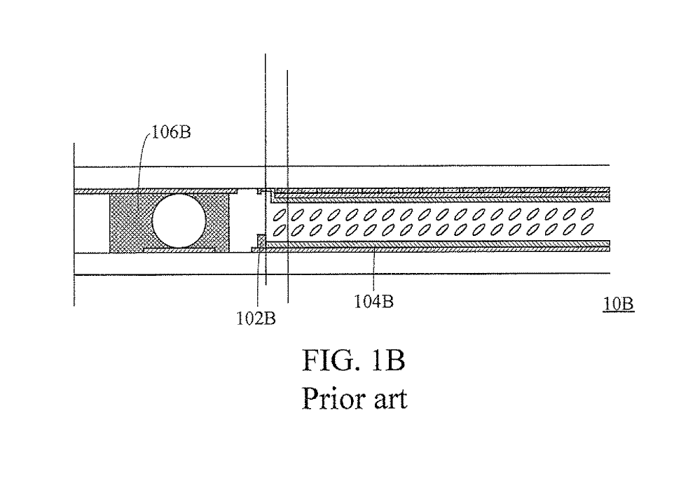

FIG. 2 is a structure sectional view illustrating a liquid crystal (LC) panel in a preferred embodiment of the present invention;

FIG. 3 is a structure sectional view illustrating a bottom substrate in the present invention; and

FIG. 4 is a flowchart illustrating a groove and a retaining wall forming in the LC panel of the present invention.

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. As such, the directional terminology is used for purposes of illustration and is in no way limiting the present invention.

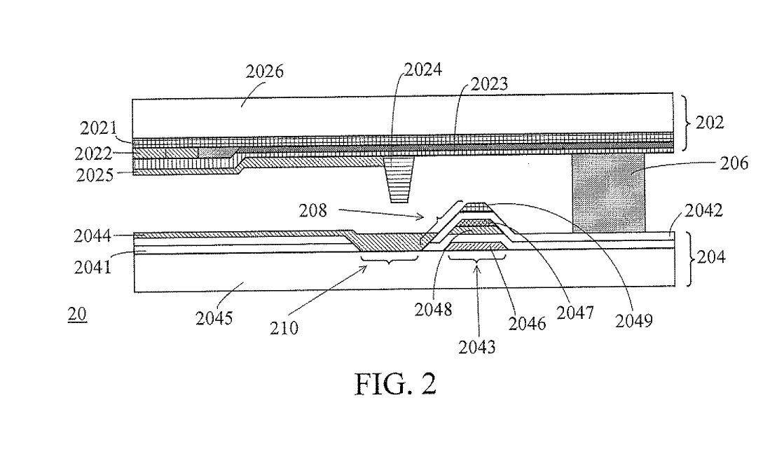

FIG. 2 is a cross-sectional structure view illustrating a liquid display panel in a preferred embodiment of the present invention. As shown in FIG. 2, the LC panel 20 includes a top substrate 202, a bottom substrate 204 and a sealant 206. The top substrate 202 is a Color Filter (CF) and includes a Black Matrix (BM) 2021, a color filter layer 2022, a transparent conductive (also called Indium Tin Oxide, ITO) layer 2023, a Photo Spacer (PS) 2024, a first alignment film 2025, a glass substrate 2026 and so on. The function of the BM 2021 in the top substrate 202 is to shelter light source and avoid the leakage of an emitting light affecting the color and the luster. The color filter layer 2022 is to provide a synergistic effect in accordance with light and LCs twisted to acquire a color result. The transparent conductive layer 2023 is to provide electricity for LC molecule sensing in the LC panel 20 so as to control the rotation of the LC molecule. The function of the PS 2024 is to maintain the cell gap between the top substrate 202 and the bottom substrate 204. The bottom substrate 204 is an array substrate and includes a glass substrate 2045, an insulated layer 2041 disposed on the glass substrate 2045, a protective layer 2042, a thin film transistor (TFT) 2043, a second alignment film 2044 and so on. It should be noted that the description above is to briefly interpret the main structure of the LC 20 and is not to limit the LC panel in the present invention only including the structures above. In addition, the fabrication of each of thin films on the top substrate 202 and the bottom substrate 204 is known by person with ordinary skilled in the art and the description thereof is omitted herein.

Please still refer to FIG. 2, in the preferred embodiment of the present invention, when the TFT 2043 is stacked and formed on the bottom substrate 204, it is to retain the thin films, which is used to fabricate the TFT 2043, at the same location on the LC panel 20 to form a first limiting component 208. Generally, the TFT 2043 is formed by a portion of the insulated layer 2041, a portion of the protective layer 2042, a first metal layer 2046, a second metal layer 2047, an amorphous silicon layer 2048 and an ITO layer 2049. The insulated layer 2041 is coated on the glass substrate 2045 and the first metal layer 2046, and the protective layer 2042 is stacked on the insulated layer 2041 and the second metal layer 2047. In the area on the side of the sealant 206, during fabricating the TFT, without adding extra process steps, a small portion in each of the layers is retained to form the first limiting component 208 having a relatively higher height, as shown in drawing. The present embodiment is using the TFT for example, but it is not limited herein. In the present invention, the first limiting component 208 is formed as a retaining wall or a bump and it is not limited herein. Moreover, at a front end of the first limiting component 208, a recessed second limiting component 210 is formed by an etching method. In the present invention, the second limiting component 210 is formed as a recess or a groove, and it is not limited herein. The second limiting component 210 can contain the second alignment film 2044, which is spread out. The second limiting component 210 is operated in cooperation with the first limiting component 208 to further prevent the second alignment film 2044 from being spread over the structure consisted of the first limiting component 208 and the second limiting component 210. Therefore, the second alignment film 2044 overlapping the sealant 206 to affect the adhesive ability of the sealant 206 can be avoided. In addition, the stacking method of the first limiting component 208 is not limited to form the shape shown in the drawings. In a different embodiment, the stacking method can be adjusted to form the first limiting component 208 with different shape and different height. Furthermore, the etching depth or width can be modified by etching different layers of the thin film to form the second limiting component 21,0 with different shape or height. For example, it is to etch on the top of the insulated layer 2041 or the top of the bottom substrate 204, and the second limiting component 210 can be formed by etching in different depth in accordance with the practical requirement.

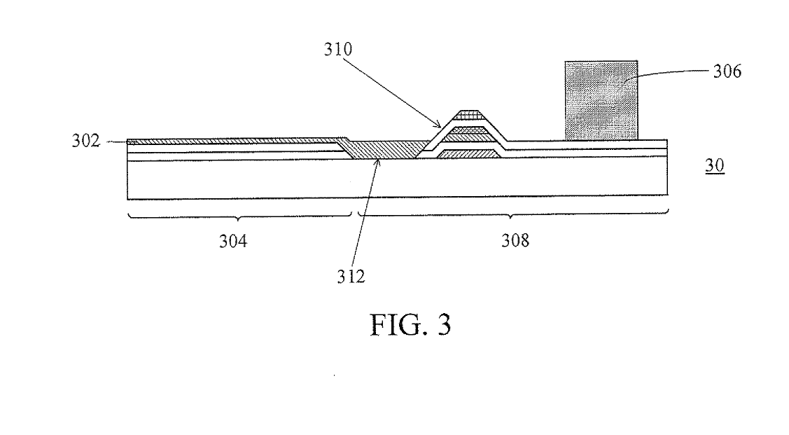

FIG. 3 is a sectional structure view illustrating the bottom substrate of the LC panel in the present invention. As shown in FIG. 3, the area where the alignment film 302 coated on the bottom substrate 30 is a display region 304 and the area where the alignment film 302 not coated on the bottom substrate 30 is an area of the sealant 306 and also a non-display region 308. The first limiting component 310 of the bottom substrate 30 is disposed on an edge of the non-display region 308. The first limiting component 310 is formed as a retaining wall or a bump and it is not limited herein. The second limiting component 312 is disposed between the first limiting component 310 and the display region 304. The second limiting component 312 is formed as a recess or a groove, and it is not limited herein. Because of the design of the first limiting component 310 and the second limiting component 312, the alignment film 302 will not be spread from the display region 304 to the non-display region 308 so as to avoid the alignment film 302 overlapping the sealant 306. In other words, comparing to respectively use only a first limiting component 310 or a second limiting component 312, the conjunction of the first limiting component 310 and the second limiting component 312 in the present invention will include a larger section and the result of stopping the diffusion of the alignment film 302 is much better.

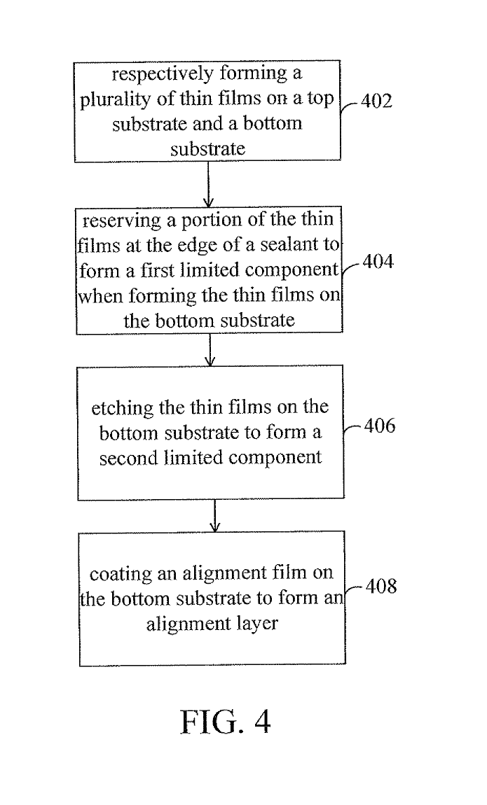

FIG. 4 is a flowchart illustrating a groove and a retaining wall formed on the LC panel of the present invention. As shown in FIG. 4, in step 402, it is respectively stacking a plurality of thin films on a top substrate and a bottom substrate. The top substrate is a glass substrate of the color filter and the bottom substrate is a glass substrate of the array substrate. In step 404, when the thin films are formed on the bottom substrate, a portion of the plurality of the thin films at the edge of the sealant is retained to form a first limiting component. The first limiting component is formed by the retained portion of the thin films. For example, a portion of the insulated layer and/or the protective layer on the bottom substrate is retained to form the first limiting component. The first limiting component is preferred to be a retaining wall or a bump, and it is not limited herein. In step 406, it is etching a plurality of the thin films on the bottom substrate to form a second limiting component. The second limiting component is preferred to be a groove or a recess, and it is not limited herein. In addition, the second limiting component is formed in an area adjacent to the first limiting component. In step 408, it is coating an alignment film on the bottom substrate to form an alignment layer. By the structure of the first limiting component and the second limiting component, during a process for Coating the alignment film, the first limiting component and the second limiting component can prevent the alignment film from being spread to the area of the sealant so as to avoid the alignment film overlapping the sealant. In other words, by the installation of the first limiting component and the second limiting component, the purpose of evenly spreading the alignment film can be achieved and the distance between the edge of the effective display region and the edge of the panel can be decreased_{—} Therefore, an ultra-thin frame can be easily achieved.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal (LC) panel, comprising a top substrate, a bottom substrate and at least one sealant, wherein the bottom substrate comprises:
a display region;
a non-display region adjacent to the display region;
a first limiting component formed to be convex at an edge of the non-display region;
a second limiting component formed to be concave between the first limiting component and the non-display region;
wherein when an alignment film is coated on the bottom substrate, the alignment film is prevented from being spread to the non-display region by a conjunction of the first limiting component and the second limiting component.

2. The LC panel according to claim 1, wherein the first limiting component is formed by stacking a plurality of thin films on the bottom substrate.

3. The LC panel according to claim 1, wherein the first limiting component is formed as a bump.

4. The LC panel according to claim 1, wherein the first limiting component is formed as a retaining wall.

5. The LC panel according to claim 1, wherein the second limiting component is formed by etching a plurality of the thin films on the bottom substrate.

6. The LC panel according to claim 1, wherein the second limiting component is formed as a recess.

7. The LC panel according to claim 1, wherein the second limiting component is fowled as a groove.

8. The LC panel according to claim 1, wherein at least one sealant is disposed on the non-display region.

9. A liquid crystal (LC) panel manufacturing method, wherein the manufacturing method comprises following steps:
respectively stacking a plurality of thin films on a top substrate and a bottom substrate;
retaining a portion of the thin films on a side of a sealant for forming a first limiting component when forming a plurality of the thin films on the bottom substrate;
etching a plurality of the thin films on the bottom substrate for forming a second limiting component; and
coating an alignment film on the bottom substrate for forming an alignment layer;
wherein by a conjunction of the first limiting component and the second limiting component, during the process to coat the alignment film, the first limiting component and the second limiting component are utilized to prevent the alignment film from being spread to an area of the sealant for avoiding the alignment film overlapping the sealant.

10. The LC panel manufacturing method according to claim 9, wherein the etching step is to form the second limiting component between a display region of the display panel and the first limiting component.
